(19) United States
(12) Patent Application Publication
(10) Pub. No.: US 2025/0345861 A1
(43) Pub. Date: Nov. 13, 2025

(54) Indexing System for Multiple Insert Lathe Tool Holder

(71) Applicant: Modern Industries, Inc., Erie, PA (US)

(72) Inventor: Timothy Sweny, Fairview, PA (US)

(73) Assignee: Modern Industries, Inc., Erie, PA (US)

(21) Appl. No.: 19/019,390

(22) Filed: Jan. 13, 2025

Related U.S. Application Data
(60) Provisional application No. 63/620,089, filed on Jan. 11, 2024.

(51) Int. Cl. B23B 29/32; B23B 3/16

(52) U.S. Cl. CPC B23B 29/32; B23B 3/16; B23B 2260/02; B23B 2260/044

(57) ABSTRACT

An indexing system for a lathe tool holder comprises a lower housing assembly with a rotary driver shaft interfaced with a tool turret and rotatable by the tool turret, a rotary driver clutch secured to the rotary driver shaft, and an outer rotary comprising an internally threaded pocket. A rotary pusher with an externally threaded portion mates with the internally threaded pocket. Rotation of the rotary driver shaft causes the rotary pusher to move linearly without rotation. An upper housing assembly mounted on the lower housing assembly comprises a sawtooth connection for a multiple insert lathe tool holder head. A camshaft driver interfaces with the tool holder head and has a cam channel that circumscribes a path that is interfaced with a stationary cam pin. Linear movement of the rotary pusher causes rotation of the camshaft driver and thereby rotation and linear movement of the tool holder head.

### BACKGROUND

Machine-driven multiple insert lathe tool holder work on Computer numerical control (“CNC”) lathes (or turning centers) that are fitted with tool turrets capable of running live tools. A CNC lathe uses a programmable computer controlled rotating chuck to spin material (usually metal or wood) that is formed into a part (the workpiece) while the tool turret holds cutting tools that interact with the workpiece to remove material, thus creating a desired finished machined configuration.

Typically, an insert is clamped into a stick tool that is clamped into one of several positions in the tool turret. The insert is typically made of carbide. As the workpiece spins, the CNC lathe is programmed to guide the insert to cut material into and across the workpiece. Machine tools with the live tooling option allow the workpiece to stop spinning so the live tools can perform non-turning operations on the workpiece, like drilling holes or milling a flat or a profile. In some cases, the CNC lathe can both spin the workpiece and utilize the live tool. The inner construction of each live tool turret is unique to each model. The live tool turret typically contains a shank with a blade or some other form of driver that drives the live tool at speeds up to 10,000 rpm or more.

### SUMMARY

What is presented is an indexing system for a lathe tool holder of a tool turret that comprises multiple tools. The indexing systems comprises a lower housing assembly that further comprises a lower housing having a post sized to fit in the tool turret, a rotary driver shaft interfaced with the tool turret and rotatable by the tool turret, a rotary driver clutch that is secured to the rotary driver shaft, an outer rotary comprising an internally threaded pocket, and a rotary pusher comprising an upper portion and a lower portion that has an externally threaded portion that mates with the internally threaded pocket of the outer rotary. Rotation of the rotary driver shaft causes the rotary driver clutch and the outer rotary to rotate and causes the rotary pusher to move linearly without rotation within the lower housing.

An upper housing assembly is mounted on the lower housing assembly. The upper housing assembly comprises a sawtooth connection on an upper portion for holding, locating, and connecting a multiple insert lathe tool holder head. A camshaft driver interfaces with the multiple insert lathe tool holder head. The camshaft driver has a cam channel that circumscribes a path. A stationary cam pin interfaces with the cam channel. An actuator block engages with the camshaft driver and the rotary pusher. Linear movement of the rotary pusher causes rotation of the camshaft driver. Linear movement of the camshaft driver is caused by the interface of the cam pin with the cam channel and thereby rotation and linear movement of the multiple insert lathe tool holder head.

In some embodiments of the indexing system a Belville spring is located around the camshaft driver and/or between the rotary driver clutch and the rotary pusher.

In some embodiments of the indexing system the cam channel circumscribes a known path such that linear motion of the camshaft driver requires the camshaft driver to be rotated clockwise and anticlockwise as the cam pin interfaces with the cam channel. In some embodiments, selecting of tools in the multiple insert lather tool holder head is effectuated by rotating the rotary drive shaft in known directions and for known times to allow the camshaft driver to rotate relative to the cam pin in the cam channel and thereby move the multiple insert lather tool holder head along the sawtooth connection.

In some embodiments of the indexing system, the sawtooth connection has an angle up to 30 degrees relative to the upper housing portion of the upper housing assembly which positions the multiple insert lathe tool holder head to sit at the angle relative to the upper housing portion of the upper housing assembly. In such embodiments, the camshaft driver is positioned to match the angle of the sawtooth connection to align the camshaft driver with a centerline of the multiple insert lathe tool holder head.

In some embodiments of the indexing system, the lower housing comprises vertical grooves in an inside diameter. The rotary pusher comprises corresponding vertical grooves on an outside surface. Dowel pins are located between the vertical grooves in the lower housing and the corresponding vertical grooves in the rotary pusher. Linear motion of the rotary pusher is caused by the dowel pins restraining rotation of the rotary pusher when the outer rotary is rotated.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a cross-section view of a multiple insert lathe tool holder that incorporates the indexing system disclosed herein;

FIG. 2 depicts a camshaft driver with a cam channel;

FIG. 3 depicts the cam pin that interfaces with the cam channel in the camshaft driver in the upper housing assembly;

FIG. 4 shows a cut out version of the multiple insert lathe tool holder of FIG. 1 showing the tool holder head seated in the locked position;

FIG. 5 shows the multiple insert lathe tool holder of FIG. 4 beginning the indexing process to bring the next tool in the tool holder head to bear;

FIG. 6 shows the multiple insert lathe tool holder of FIG. 5 progressing through the indexing process to bring the next tool in the tool holder head to bear; and

FIG. 7 shows the multiple insert lathe tool holder of FIG. 6 almost completing the indexing process to bring the next tool in the tool holder head to bear.

### DETAILED DESCRIPTION

The cost of new CNC lathes with live tools typically starts at about $100,000 for low-end smaller sized machines and can exceed $1,000,000 for large machines with multiple tool turrets, sub spindles, very large chucks, and other features. Prices in the range of $250,000 to $400,000 are not uncommon for medium-sized machines with modest-to upper-level features. At these price points and considering the cost of skilled labor, machine shops are continuously trying to keep their CNC lathes in operation, i.e. increasing the percentage of time the CNC lathe is cutting a part which means more parts made per hour, which translated into more revenue per hour and, therefore, more profit for the machine shop. Activities which create an idle CNC lathe include maintenance downtime for repair, breakdowns, employee break times, stopping the CNC lathe to index or change out inserts, and set up from one job to the next.

Tool turrets in CNC lathes typically contain 12 or 24 positions. Conventional stick tools allow placement of one insert into each position of the tool turret, therefore a maximum of 12 or 24 tools maybe included in each CNC lathe at any one time. A CNC lathe is typically configured with a set of tools that are expected to be used for the manufacture of a part and ideally, all of the tools that are required for a single part fit on a single CNC lathe. If the CNC lathe is required to manufacture a different part, it may be that the tools already installed are not appropriate for the different part, and a different setup is required. In such cases, the tools have to be swapped out and replaced in favor of a different tool setup. This takes employee time and CNC lathe downtime to ensure the new tool is properly installed, aligned, configured, etc. Any time the machine is down for setup, it is not making a saleable product.

Machine shops also seek to increase the amount of time that the CNC lathe can operate unattended. This lowers the cost of running the CNC lathe per hour as employees can be assigned to other tasks. Unattended machining is sometimes referred to as “lights out machining”. New sensors on CNC lathes can detect problems and stop the machine or send notification via text or email thus avoiding major problems like manufacturing of scrap or a machine crash. However, the limiting factor in how long a CNC lathe can run unattended is the life of the cutting insert, which needs to be changed when it gets worn. Normally this occurs on the “roughing” inserts first since they remove the most material. When an insert needs to be changed or “indexed” a human operator needs to stop the CNC lathe machine and change the inserts. This limits the unattended duration.

Another cost reduction method is to reduce the cycle time between parts through feed-speed and depth of cut modifications which can be improved by employing the latest technology inserts and tool holders.

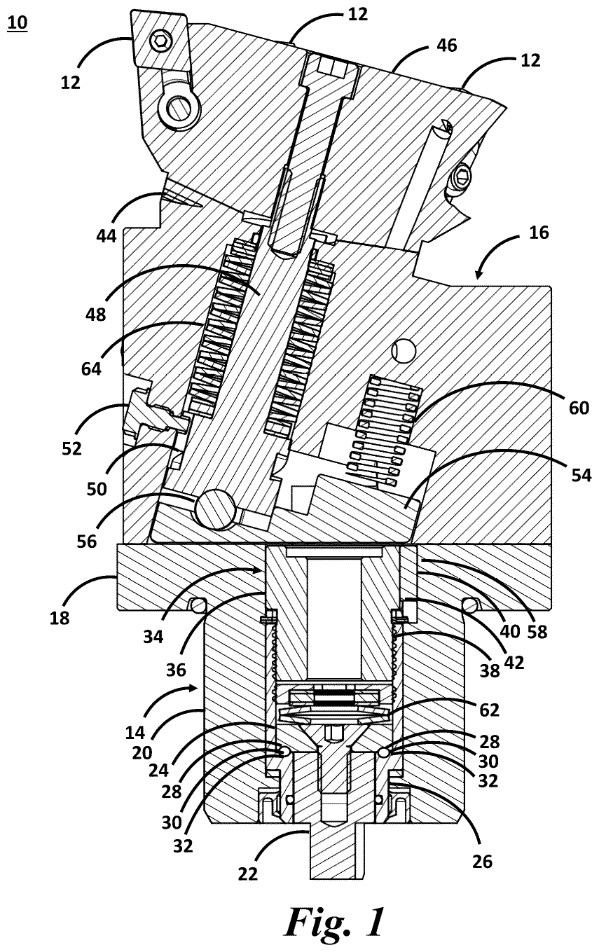

FIG. 1 shows a cross-sectional view of a lathe tool holder 10 of a tool turret mounted to a CNC machine (not shown) that comprises multiple tools 12. The lathe tool holder 10 comprises a lower housing assembly 14 and an upper housing assembly 16. The lower housing assembly 14 comprises a lower housing 18 that has a post 20 sized and shaped to fit in the tool turret. There are a variety of tool turrets that are available so the configuration of the post 20 is generally specific to the tool turret. Protruding out of the bottom of the post 20 is a rotary driver shaft 22 that interfaces with the tool turret and is rotatable by the tool turret. A rotary driver clutch 24 is secured to the rotary driver shaft 22. An outer rotary 26 comprises an internally threaded pocket.

The bottom of the rotary driver clutch 24 is machined with a series of half-spherical pockets 28 which each hold one of an equivalent number of clutch driver balls 30. The outer rotary 26 contains corresponding half-spherical pockets 32 that allow the clutch driver balls 30 to be seated between the rotary driver clutch 24 and the outer rotary 26.

A rotary pusher 34 comprising an upper portion 36 and a lower portion 38. The lower portion 38 has an externally threaded portion that mates with the internally threaded pocket of the outer rotary 26.

The upper portion 36 of rotary pusher 34 contains vertical grooves 42 that align with corresponding vertical grooves 58 machined into the inside diameter of the lower housing 18. Dowel pins 40 are located in the space defined by these vertical grooves 42, 58.

When the tool turret operates, the rotary driver shaft 22 turns at a designated RPM, causing the rotary driver clutch 24 to also turn. As the rotary driver clutch 24 turns, the clutch driver balls 30 cause the outer rotary 26 to also turn. When the outer rotary 26 turns, the rotary pusher 34 does not rotate but instead moves linearly as it is restrained from turning by the dowel pins 40 which act as linear movement guides.

An upper housing assembly 16 is mounted on the lower housing assembly 14. The upper housing assembly 16 comprises a sawtooth connection 44 on an upper portion for holding, locating, and connecting a multiple insert lathe tool holder head 46 that has several tools 12 located around the periphery of the multiple insert lathe tool holder head 46. The sawtooth connection 44 shown in the figures is machined at an approximate 15-degree angle which allows the multiple insert lathe tool holder head 46 to also sit at 15 degrees relative to the top surface of the upper housing assembly 16. This provides appropriate tool clearance as the lathe tool holder 10 operates. The actual angle that the sawtooth connection 44 is machined relative to the top surface of the upper housing assembly 16 varies according to the application. It could be that no sawtooth connection 44 is machined with no angle or up to an angle of 30 degrees relative to the surface of the upper housing assembly 16. In every instance, the camshaft driver 48 is positioned to match the angle of the sawtooth connection 44 to align the camshaft driver 48 with a centerline of the multiple insert lathe tool holder head 46.

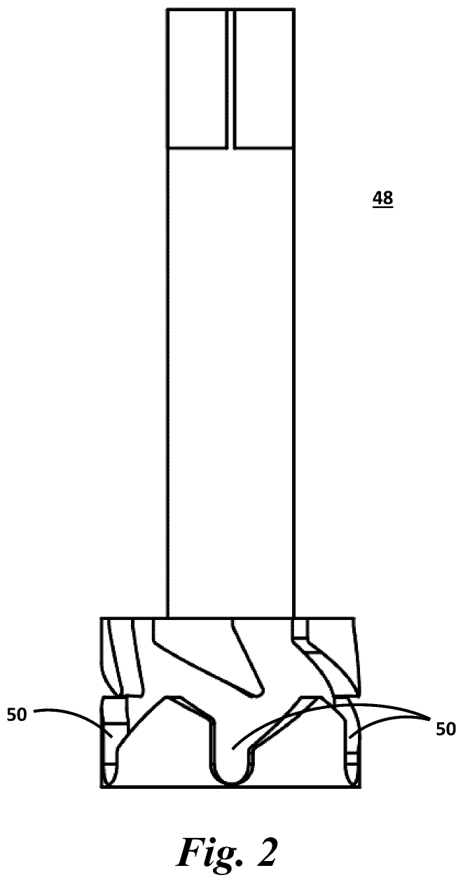

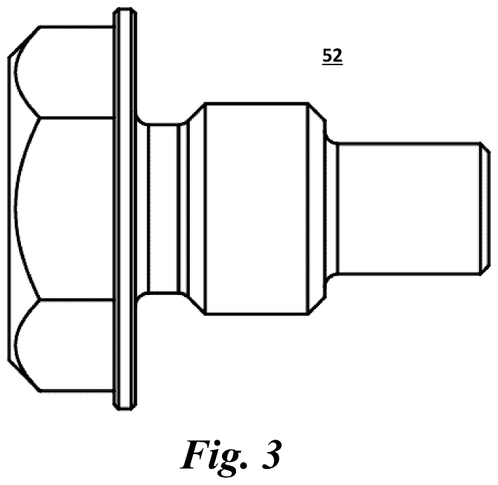

The upper housing assembly 16 is machined to house the camshaft driver 48 and its related assemblies described in more detail below. The camshaft driver 48 is positioned within upper housing assembly 16 at the same angle as the sawtooth connection 44. In the embodiment shown in FIG. 1, this angle is 15 degrees relative to the centerline of the upper housing assembly 16 to keep the central axis of the camshaft driver 48 axis aligned with the centerline of the multiple insert lathe tool holder head 46. The camshaft driver 48 interfaces with the multiple insert lathe tool holder head 46 such that movement of the camshaft driver 48 also moves the multiple insert lathe tool holder head 46. FIG. 2 shows a camshaft driver 48. As best understood by comparing FIGS. 1 and 2, the camshaft driver 48 has a cam channel 50 that circumscribes a path. FIG. 3 shows a cam pin 52. As best understood by comparing FIGS. 1, 2, and 3 the stationary cam pin 52 interfaces with the cam channel 50. An actuator block 54 engages with the camshaft driver 48 and the rotary pusher 34. The top of the actuator block 54 is machined with a riser that holds a camshaft driver ball 56 which pushes against a corresponding mating pocket in the bottom of the camshaft driver 48. The actuator block 54 also engages an actuator block return spring 60 that biases the actuator block 54 back to its resting position.

FIGS. 3 through 7 illustrate the indexing system that is provided by the system disclosed herein wherein linear movement of the rotary pusher 34 causes rotation of the camshaft driver 48 and linear movement of the camshaft driver 48 is caused by the interface of the cam pin 52 with the cam channel 50 and thereby rotation and linear movement of the multiple insert lathe tool holder head 46.

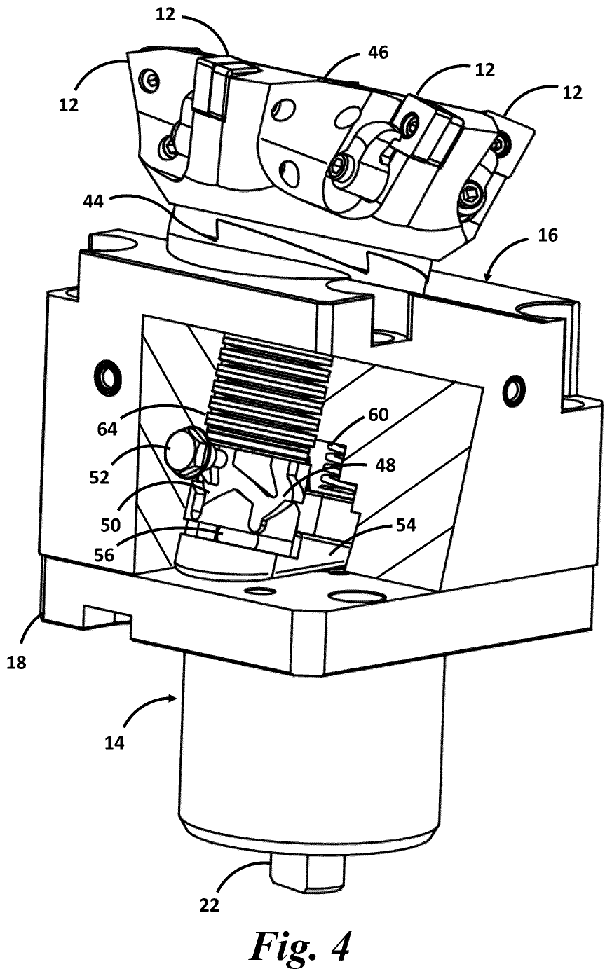

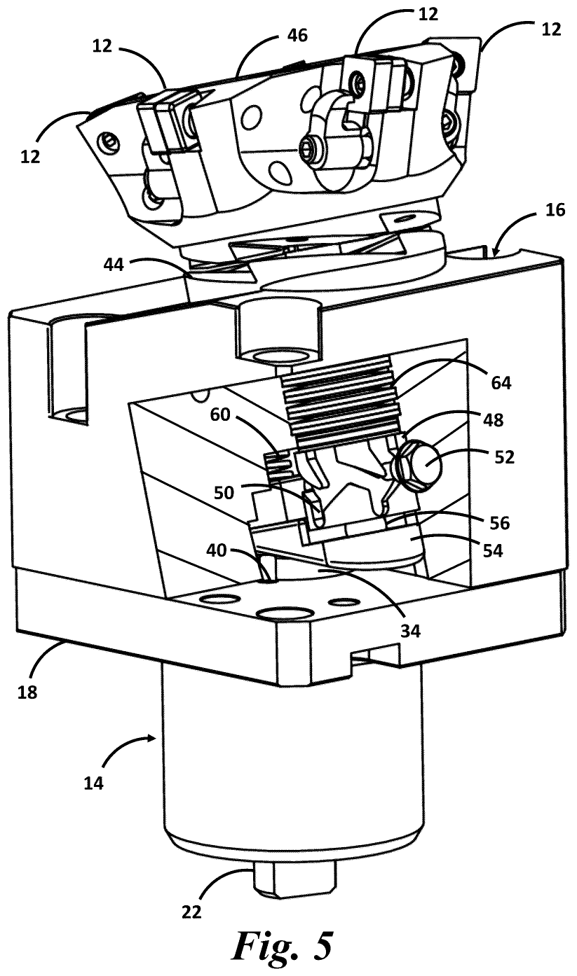

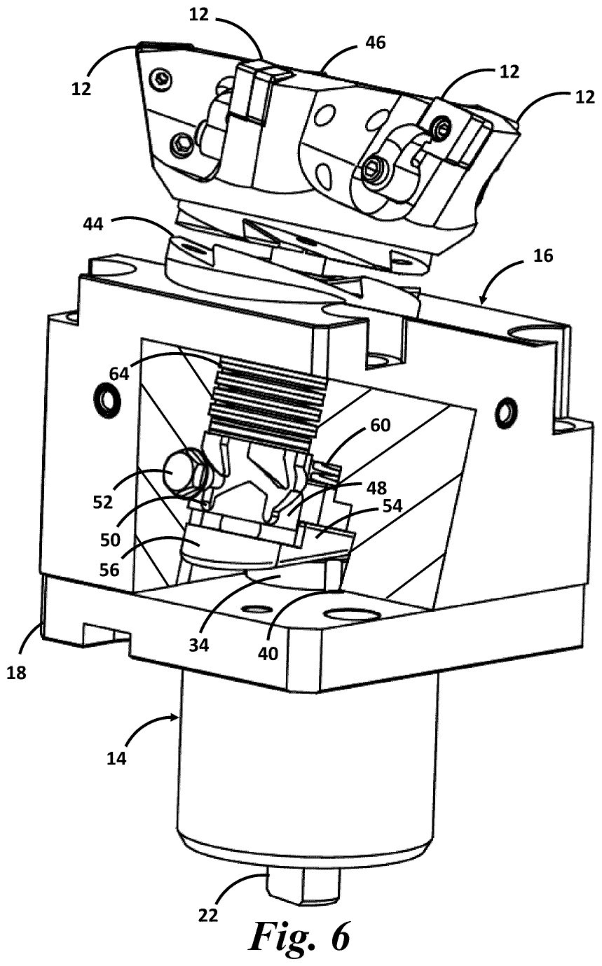

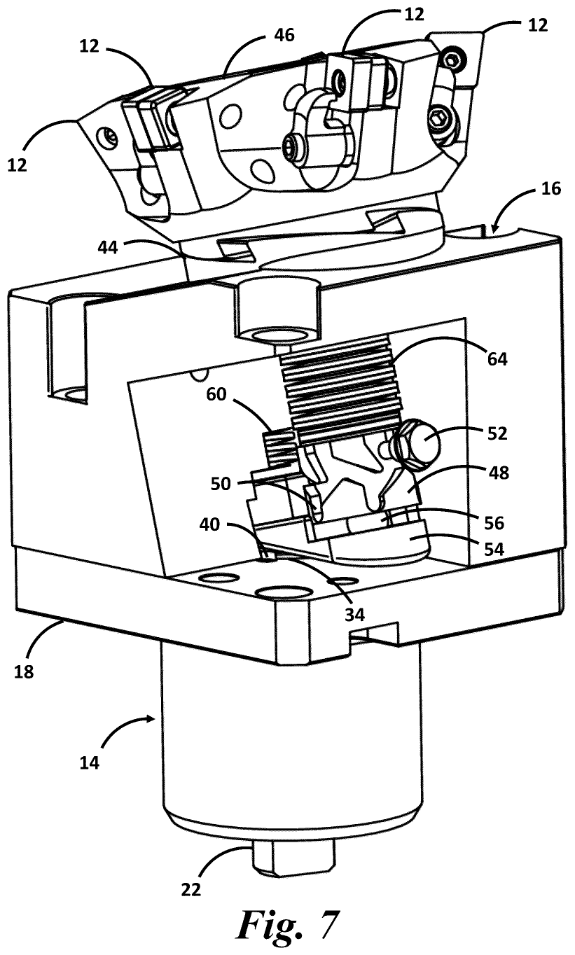

As best understood by comparing FIGS. 1 and 4, when the multiple insert lathe tool holder head 46 is in a locked position, it is seated against the sawtooth connection 44 on the upper housing assembly. In operation and as best understood by comparing FIGS. 1 and 4-7, the CNC Machine tool via the programable live tool turret, turns the rotary driver shaft 22, causing the rotary pusher 34 to travel upwards along the dowel pins 40. The top of the rotary pusher 34 engages the bottom of the actuator block 54 causing the actuator block 54 to move upwards. This pushes against the camshaft driver ball 56 and causes the camshaft driver 48 to also move upwards. However, the presence of the stationary cam pin 52 in the cam channel 50 causes the camshaft driver 48 to rotate along the cam channel 50 to allow the linear movement of the camshaft driver 48. With a known path defined by the cam channel 50, the CNC machine can be programmed to move the camshaft driver 48 linearly to allow known movement of the multiple insert lathe tool holder head 46. As shown in FIGS. 4 through 7, following the known path defined by the cam channel 50 the tool turret is activated to the camshaft driver 48 to move upwards to release the sawtooth connection 44 that mates the multiple insert lathe tool holder head 46 to the upper housing assembly 16 (FIG. 5) and rotates, first clockwise (FIG. 6) to index to a different tool 12 on the multiple insert lathe tool holder head 46, then counterclockwise rotation (FIG. 7) to seat the multiple insert lathe tool holder head 46 back onto the sawtooth connection 44.

Because the path of the cam channel 50 is known, the CNC machine can be programmed such that the tool turret can be activated to precisely drive the rotary drive shaft 22 to move the internal components of the system. The linear motion of the camshaft driver 48 requires clockwise and anticlockwise to navigate the cam pin 52 interface with the cam channel 50. In some embodiments, selecting of tools 12 in the multiple insert lather tool holder head 46 is effectuated by rotating the rotary drive shaft 22 in known directions and for known times to allow the camshaft driver 48 to rotate relative to the cam pin 52 in the cam channel 50 and thereby move the multiple insert lather tool holder head 46 along the sawtooth connection 44.

The lathe tool holder 10 incorporates a clutch mechanism to account for inadvertent operation of the drive mechanism of the tool turret should the drive mechanism ever be operated to travel beyond the range of the camshaft driver 48. A clutch Belville spring 62 is located between the rotary driver clutch 24 and the rotary pusher 34. A main Belville spring 64 is located around the camshaft driver 48. The main Belville spring 64 is selected to compress enough to lift the multiple insert lathe tool holder head 46 to a selected maximum design position. The clutch Bellville spring 62 is designed to compress at a greater force than is needed to compress the main Bellville spring 64. If the tool turret operates in the upward direction beyond the range of the camshaft driver 48, (i.e. past the working range of the main Bellville spring 64), the main Bellville spring 62 will create a force great enough to compress the clutch Bellville spring 62. As the clutch Bellville spring 62 is compressed, the rotary driver clutch 24 lifts up, allowing the clutch driver balls 30 to exit the half-spherical pockets 28, where they drive the outer rotary 26. When this happens, the clutch driver balls 30 are free to travel in the raceway of the rotary driver clutch 24. In this state the rotary driver shaft 22 can turn freely without translating linearly. If the tool turret operates in the downward direction (towards a locked or “cutting” position) and over travels, the rotary pusher 34 will bottom out within the lower housing assembly 16.

Many modifications and alterations will occur to others upon reading and understanding the preceding specification. It is intended that the invention be construed as including all such alterations and modifications in so far as they come within the scope of the appended claims or the equivalents of these claims.

What is claimed is:

1. An indexing system for a lathe tool holder of a tool turret that comprises multiple tools comprising:
a lower housing assembly comprising:
a lower housing having a post sized to fit in the tool turret;
a rotary driver shaft interfaced with the tool turret and rotatable by the tool turret;
a rotary driver clutch that is secured to said rotary driver shaft;
an outer rotary comprising an internally threaded pocket; and
a rotary pusher comprising an upper portion and a lower portion that has an externally threaded portion that mates with said internally threaded pocket of said outer rotary;
wherein rotation of said rotary driver shaft causes said rotary driver clutch and said outer rotary to rotate and causing said rotary pusher to move linearly without rotation within said lower housing; and
an upper housing assembly mounted on said lower housing assembly, said upper housing assembly comprising:
a sawtooth connection on an upper portion for holding, locating, and connecting a multiple insert lathe tool holder head;
a camshaft driver that interfaces with said multiple insert lathe tool holder head and having a cam channel that circumscribes a path;
a cam pin that is stationary and interfaces with said cam channel; and
an actuator block that engages with said camshaft driver and said rotary pusher;
wherein linear movement of said rotary pusher causes rotation of said camshaft driver and linear movement of said camshaft driver is caused by the interface of said cam pin with said cam channel and thereby rotation and linear movement of said multiple insert lathe tool holder head.

2. The indexing system of claim 1 further comprising a Belville spring located around said camshaft driver and/or between said rotary driver clutch and said rotary pusher.

3. The indexing system of claim 1 further comprising: said cam channel circumscribes a known path such that linear motion of said camshaft driver requires said camshaft driver to be rotated clockwise and anticlockwise as said cam pin interfaces with said cam channel.

4. The indexing system of claim 1 further comprising:
said cam channel circumscribes a known path such that linear motion of said camshaft driver requires said camshaft driver to be rotated clockwise and anticlockwise as said cam pin interfaces with said cam channel;
wherein selecting of tools in said multiple insert lather tool holder head is effectuated by rotating said rotary drive shaft in known directions and for known times to allow said camshaft to driver to rotate relative to said cam pin in said cam channel and thereby move said multiple insert lather tool holder head along said sawtooth connection.

5. The indexing system of claim 1 further comprising:
said sawtooth connection has an angle up to 30 degrees relative to said upper housing portion of said upper housing assembly which positions said multiple insert lathe tool holder head to sit at said angle relative to said upper housing portion of said upper housing assembly;
said camshaft driver is positioned to match said angle of said sawtooth connection to align said camshaft driver with a centerline of said multiple insert lathe tool holder head.

6. The indexing system of claim 1 further comprising:
said lower housing comprises vertical grooves in an inside diameter;
said rotary pusher comprises corresponding vertical grooves on an outside surface; and
dowel pins located between said vertical grooves in said lower housing and said corresponding vertical grooves in said rotary pusher;
wherein linear motion of said rotary pusher is caused by said dowel pins restraining rotation of said rotary pusher when said outer rotary is rotated.
